(19) United States
(12) Patent Application Publication
(10) Pub. No.: US 2015/0145536 A1
(43) Pub. Date: May 28, 2015

(54) Methods and Systems for Production Testing of Capacitors

(71) Applicant: Telefonaktiebolaget LM Ericsson (publ), Stockholm (SE)

(72) Inventor: Jeroen KUENEN, BEUNINGEN (NL)

(73) Assignee: Telefonaktiebolaget LM Ericsson (publ), Stockholm (SE)

(21) Appl. No.: 14/091,452

(22) Filed: Nov. 27, 2013

(51) Int. Cl. G01N 27/22; G01B 7/00

(52) U.S. Cl. CPC G01N 27/22; G01B 7/00
USPC 324/681

(57) ABSTRACT

Systems and methods provide for testing a capacitor. The method includes: selecting a capacitor to be tested; generating an frequency signal from a source voltage which passes through a resistor, while connecting and disconnecting the capacitor, which results in an output signal; and measuring a relative level of a sideband associated with the output signal to estimate a size of the selected capacitor.

### TECHNICAL FIELD

The present invention relates generally to capacitors and more specifically to testing systems and methods associated with the testing of capacitors.

### BACKGROUND

At its inception radio telephony was designed, and used for, voice communications. As the consumer electronics industry continued to mature, and the capabilities of processors increased, more devices became available for use that allowed the wireless transfer of data between devices. Also more applications became available that operated based on such transferred data. Of particular note are the Internet and local area networks (LANs). These two innovations allowed multiple users and multiple devices to communicate and exchange data between different devices and device types. With the advent of these devices and capabilities, users (both business and residential) found an increasing need to transmit data, as well as voice, from mobile locations.

The infrastructure and networks which support this voice and data transfer have likewise evolved. Limited data applications, such as text messaging, were introduced into the so-called “2G” systems, such as the Global System for Mobile (GSM) communications. Packet data over radio communication systems were implemented in GSM with the addition of the General Packet Radio Services (GPRS). 3G systems and, then, even higher bandwidth radio communications introduced by Universal Terrestrial Radio Access (UTRA) standards made applications like surfing the web more easily accessible to millions of users (and with more tolerable delay). Another radio access technology (RAT), Wideband Code Division Multiple Access (WCDMA) which is an improvement to the 2G systems, can also be found in use.

Even as new network designs are rolled out by network manufacturers, future systems which provide greater data throughputs to end user devices are under discussion and development. For example, the so-called 3GPP Long Term Evolution (LTE) standardization project is intended to provide a technical basis for radiocommunications in the decades to come. All of this change and improvement has led to an increase in the quantity of devices and the need to be more efficient in all aspects of manufacturing and testing of such devices and their components. One example is a System-on-Chip (SOC) which is a component often used in devices, e.g., mobile phones and other electronic devices, wherein all of the circuits for a complete working product are disposed on a single chip.

For example, recently SOCs are being manufactured with integrated or embedded crystal oscillators on the die, to avoid the need for an external crystal oscillator (XO) module. With the integrated XO only an external crystal is required, which is less expensive than a complete XO module. However, for most standards, such as GSM, LTE, and Global Positioning System (GPS) the frequency accuracy of the integrated XO is not sufficient.

It is possible to measure the frequency error of a device (e.g., a mobile phone) during production or during its normal operation. The determined error can then be corrected by adjusting the capacitance around the crystal to tune the crystal's frequency in small increments, e.g., 1 ppm. An implementation for testing and error correction is shown in FIG. 1. FIG. 1 shows a schematic of a circuit 2 which includes a metal-oxide-semiconductor transistor (MOST) M1 10 which is the active device and which makes the crystal 4 oscillate. An amplifier (AMP) 12 increases the voltage swing to drive downstream circuitry (not shown). There are two capacitor banks Capbank_p 6 and Capbank_n 8 which can be individually controlled to tune the frequency of the crystal 4, by individually turning individual capacitors in the bank 6 and 8 on and off to change the oscillation frequency of crystal 4 in a manner which is known by those skilled in the art.

Device manufacturers typically use circuitry like that shown in FIG. 1 to tune the frequency of the crystal 4. To reduce testing time, the manufacturers rely on monotonicity of the Capbanks 6, 8, i.e., that the capacitance of a capacitor bank will increase monotonically as input code increases. Therefore, during production testing of the chip, both presence and monotonicity of the Capbanks 6, 8 are tested. The crystal is present on the load board and the XO output is fed to a tester. The frequency of the XO is measured by the tester for each setting of the capacitor banks (Capbanks 6, 8). However, this method of testing has disadvantages.

Firstly, the measurement time is long. To measure to an accuracy of 1 ppm, a measurement time of 10 ms is typically needed assuming an XO frequency of 52 MHz, a timing resolution of 1 ns of the tester and some margin for noise. Also, for every capacitor in the bank, this 10 ms measurement has to be repeated. Secondly, false rejects of chips where the crystal is being connected via pogo pins to the chip occur at a higher than desired rate. The series inductance and resistance of the pogo pins cause issues with starting the oscillation of the crystal 4 which results in a significant number of rejections.

Accordingly, it would be desirable to provide new testing systems and methods for capacitors which avoid or reduce the above described drawbacks.

### SUMMARY

Exemplary embodiments describe methods and systems for testing capacitors. By using the exemplary embodiments, the testing time can be reduced as compared to conventional testing methods.

According to an embodiment there is a method for testing a capacitor among a plurality of capacitors. The method includes: selecting a capacitor to be tested; generating a frequency signal from a source voltage which passes through a resistor, while connecting and disconnecting the capacitor, which results in an output signal; and measuring a relative level of a sideband associated with the output signal to estimate a size of the selected capacitor.

According to an embodiment there is a device configured to test a capacitor. The device includes: the device configured to select a capacitor to be tested among a plurality of capacitors; a source voltage configured to generate a frequency which passes through a resistor, while connecting and disconnecting the capacitor, which results in an output signal; and the device configured to measure a relative level of a sideband associated with the output signal to estimate a size of the selected capacitor.

According to an embodiment there is a system for testing a capacitor in a bank of capacitors, the system includes: a means for selecting a capacitor to be tested; a means for generating a frequency signal from a source voltage which passes through a resistor, while connecting and disconnecting the capacitor, which results in an output signal; and a means for measuring a relative level of a sideband associated with the output signal to estimate a size of the selected capacitor.

### BRIEF DESCRIPTION OF THE DRAWINGS

The accompanying drawings illustrate exemplary embodiments, wherein:

FIG. 1 illustrates a schematic of a testing circuit;

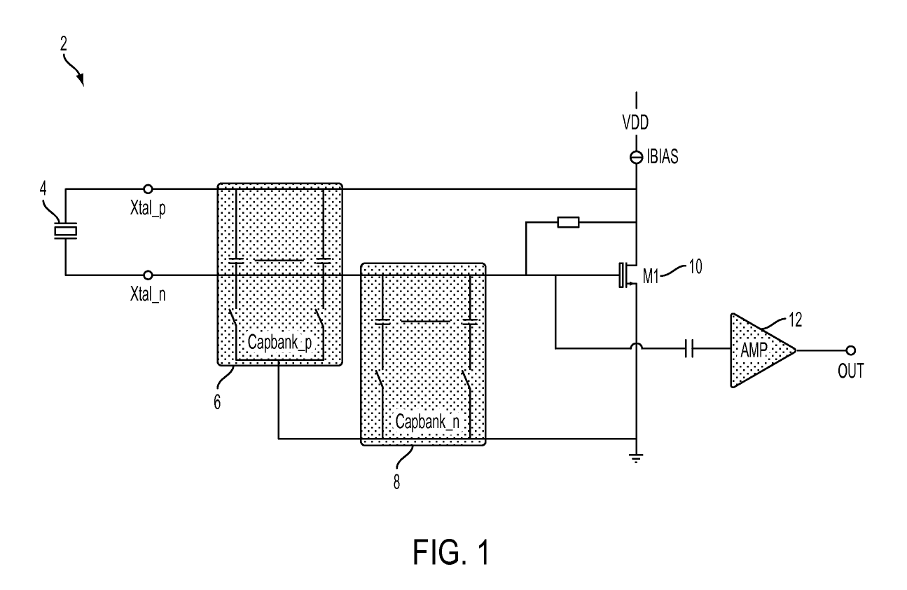

FIG. 2 is a schematic showing a setup of a capacitor bank test on test equipment (ATE) according to an embodiment;

FIG. 3 illustrates a spectrum out of the crystal oscillator when one of the capacitors is toggled according to an embodiment;

FIG. 4 is a schematic showing a setup of a capacitor bank test on-chip according to an embodiment; and

FIG. 5 is a flowchart illustrating a method according to exemplary embodiments.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

As described in the Background section various conventional methods for testing the capacitors used in capacitor banks for tuning oscillators can be relatively lengthy. Exemplary systems and methods for testing capacitors according to embodiments of the present invention are described below. While crystal oscillator (XO) capacitors are used to describe the testing methods and systems, it is to be understood that embodiments are not restricted to XO circuitry only. Instead, as would be understood by one of ordinary skill in the art, in most instances where a capacitor is connected to an external node, embodiments can be used to measure values of the capacitor.

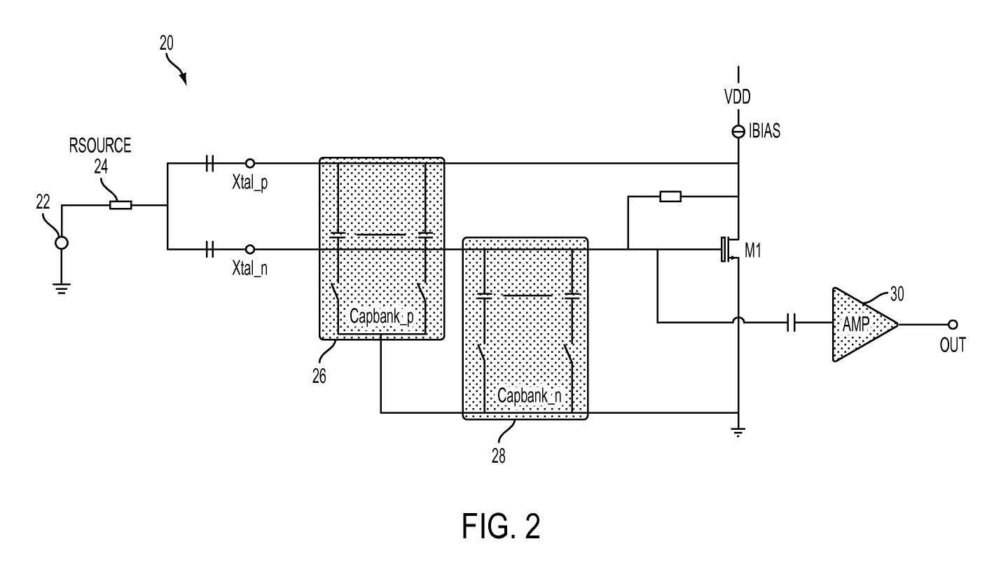

According to an embodiment, a configuration to test capacitor banks using test equipment (ATE) is shown in FIG. 2. FIG. 2 shows a testing circuit schematic 20 which includes a voltage source 22 and a source resistance (Rsource) 24. There are two capacitor banks, Capbank_p 26 and Capbank_n 28 which, with Rsource 24, form a low-pass filter. In this embodiment, there is no crystal for providing the frequency in this configuration, instead the frequency (signal) is provided by the voltage source 22. When one of the capacitors in either one of the capacitor banks is toggled, the corner frequency of this low-pass filter toggles, and therefore the amplitude and the phase of the signal at the input of the amplifier (AMP) 30 toggles as well. Accordingly, the output signal experiences both amplitude modulation (AM) and phase modulation (PM). The AMP 30 normally has enough gain that the AM is removed by the gain, however the PM typically remains. While FIG. 2 shows an embodiment where when a size of the selected capacitor is compared to the size of all the other capacitors being used, e.g., all of the other capacitors in both Capbank_p 26 and Capbank_n 28, an alternate embodiment can be that a circuit is made with just a single capacitor bank which may or may not be grounded.

The low-pass filter in testing circuit schematic 20 has a relatively high corner frequency compared to a 52 MHz main tone, so the sideband level due to the PM resulting from toggling the capacitor to be tested is small. According to an embodiment, the sideband level is proportional to the ratio of the toggling capacitor over the fixed capacitor. The toggling capacitor can be situated in either the P or the N bank of capacitors, Capbank_p 26 and Capbank_n 28, respectively.

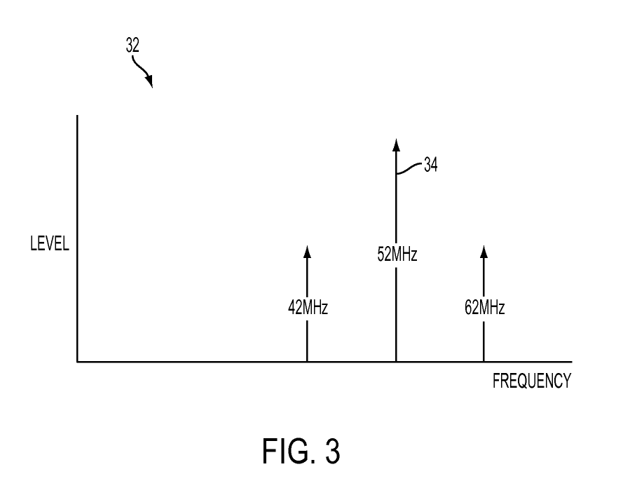

Toggling one of the capacitors at, for example, 10 MHz, in the capacitor banks (Capbank_p 26 and/or Capbank_n 28) generates an output having a certain frequency spectrum, as shown in FIG. 3. More specifically, FIG. 3 shows a graph 32 with three frequencies (tones) being output. In FIG. 3, the main tone 34 has a frequency of 52 MHz and also has the highest level. On each side of the main tone 34, at an offset of 10 MHz, a sideband occurs, e.g., at 42 MHz and 62 MHz. The relative level of the side bands compared to the main tone 34 is proportional to the size of the toggled capacitor relative to the fixed (non-toggling) capacitor size. According to an embodiment, assuming a small modulation index and that the resistance value of the external resistor Rsource 24 is known, the relative level of the sideband can be measured either by the ATE or on chip (the on chip embodiment is described in more detail below) to determine the size of the capacitor which has been toggled. This can be performed during production, e.g., by testing equipment, or during operation of the device in which the capacitor bank is operating to tune the frequency of a crystal. However, according to other embodiments, a high modulation index could be used.

According to an embodiment, the ATE can sample the output of the XO circuit, which in this embodiment is circuitry of an XO circuit without the crystal, (while embodiments, as shown in FIG. 2, do not use an XO, for simplicity the circuit is still called herein an integrated XO circuit) and calculate a Fast Fourier Transform (FFT) of the sampled signal. The difference between the 52 MHz line frequency bin and the 42 MHz frequency bin is then a measure for the size of the capacitor that is toggled.

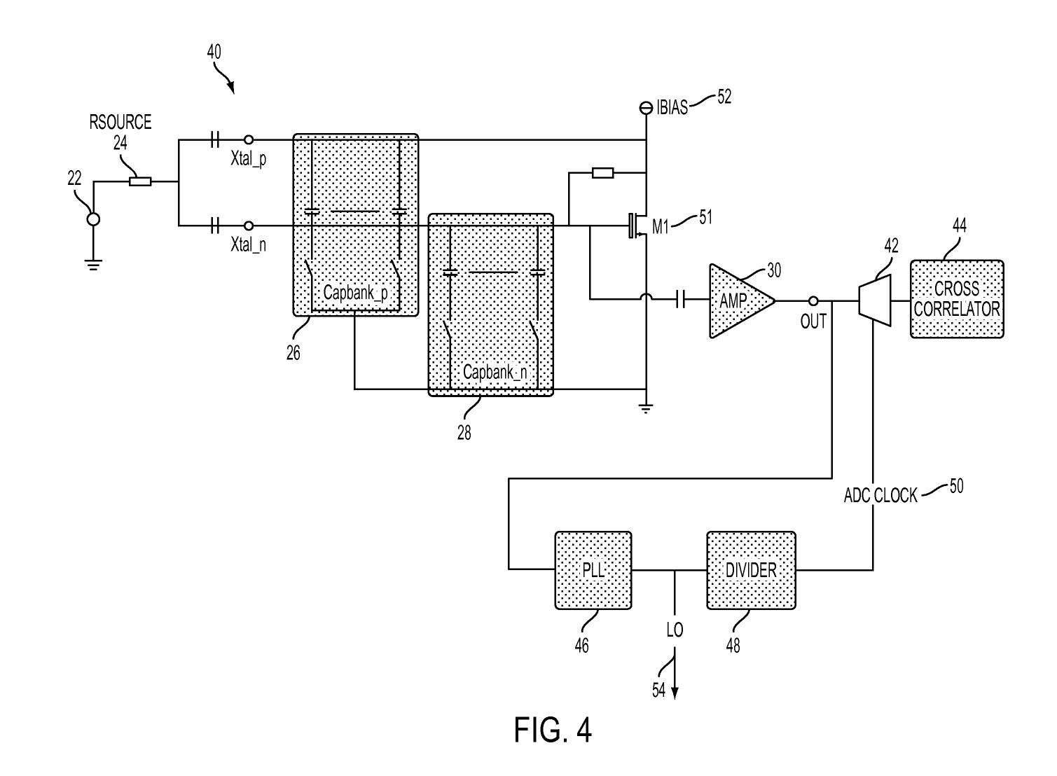

According to another embodiment, the signal level of the main tone and its sideband can be measured in the digital domain, e.g., after analog-to-digital conversion of the signal, when performing on-chip measurements. For example, according to an embodiment, an XO output signal can be provided to an analog-to-digital converter (ADC). The level of the tones (main and sideband) can be determined by a cross correlator in two subsequent measurements or by Design for Test (DFT) circuitry. This on-chip method is now described in more detail with respect to FIG. 4.

According to an embodiment, there is a block schematic 40 as shown in FIG. 4 of a circuit which can be used to measure the sideband level on-chip. FIG. 4 includes a voltage source 22, the Rsource 24 resistor, the two capacitor banks (Capbank_p 26 and Capbank_n 28), the AMP 30, an ADC 42, a cross correlator 44, a phase locked loop (PLL) 46, a divider 48, an ADC clock signal 50, the MOST M1 51 and current Ibias 52 (which is not always on). These elements will be described in more detail below.

In a manner similar to the above described ATE embodiment, in this on-chip embodiment there is no crystal for providing the frequency in this configuration, instead the frequency (signal) is provided by the voltage source 22 in combination with resistor 24. When one of the capacitors in the capacitor bank 26 or 28 is toggled, the corner frequency of the low-pass filter formed by capacitor banks 26, 28 and resistor 24, toggles, and therefore the amplitude and the phase of the signal at the input of the amplifier (AMP) 30 toggles as well. Accordingly, as described above, there is both AM and PM occurring to the output signal. The AMP 30 normally has enough gain that the AM modulation is removed by the gain, however the PM typically remains.

The low-pass filter 24, 26, 28 in testing circuit schematic 40 has a relatively high corner frequency compared to a 52 MHz main tone, so the sideband level due to the PM is small. Toggling one of the capacitors, in the capacitor banks (Capbank_p 26 and/or Capbank_n 28) generates an output as shown in FIG. 3 (and described above). The relative level compared to the main tone 34 is proportional to the size of the toggled capacitor relative to the fixed (non-toggling) capacitor size. According to an embodiment, assuming a small modulation index and that the external resistor Rsource 24 is known, the relative level of the sideband can be measured on-chip.

According to the embodiment of FIG. 4 for measuring the relative level of the sideband on-chip, the ADC 42 uses a sample clock signal 50 which is generated by the PLL 46 and a divider 48. The PLL 46 filters out the sidebands introduced by the toggling at, for example, 10 MHz. The loop bandwidth of the PLL 46 can, for example, be 50 kHz and the generated sidebands at the offset frequency described above are removed by the PLL 46, i.e., the PLL 46 effectively filters out the 10 MHz sidebands and delivers a clean LO signal 54. This filtering by the PLL 46 can be desirable as otherwise the 10 MHz sidebands would be most of the ADC clock signal 50 and consequently no sidebands would appear in the ADC output, which sidebands in the ADC output are desirable.

According to an embodiment, during the measurement of the capacitors shown in the block schematic 40 the bias source Ibias 52 can be disabled which results in the MOST M1 51 not carrying any bias current. However, the setup to test the capacitor banks 26 and 28 does not prohibit the testing of MOST M1 51 and its bias source Ibias 52, if desired. Due to the coupled capacitors, the direct current (DC) voltages around M1 51 can be tested via a DC bus (not shown). The bias source Ibias 52 can be enabled which allows for the drain and gate voltage of M1 51 to be measured. This validates the bias source Ibias 52 and MOST M1 51.

Numerous advantages and benefits flow from these embodiments although they are not required to be present in each embodiment. For example, according to an embodiment, there is no need for an external crystal on the load board, instead a strong input signal can be used that drives the integrated XO circuitry reliably. The chance of failing chips, e.g., no startup of the XO, under ATE conditions is reduced as compared to conventional methods which use the crystal as part of the test setup. Measurement time can be significantly reduced when measuring with the on chip method. For example, one measurement can be performed in about 10 μs, e.g., 5-15 μs, excluding the time needed for controlling the chip settings. This is significantly faster than conventional times which are around 10 ms for measurement time.

Embodiments described herein also allow for there to be no change to the integrated XO circuitry to enable measurement of the capacitor banks Additionally, the load board becomes simpler. For example, a resistor is smaller and less critical to place than a crystal, especially when the load board needs to support multi-side measurements, e.g., multiple chips measured simultaneously. Also, according to an embodiment, the ATE measurement can be performed on a standard tester, for which no additional modules are needed, to accurately and quickly measure the frequency, thereby reducing the overall test costs.

According to an embodiment, the value of a capacitor connected to an external chip node can be measured by inserting a source resistor and toggling a capacitor on/off. Subsequently the introduced sideband relative to the main tone can be measured. This and other embodiments described herein, can be performed for both integrated XO circuitry and other circuitry where a capacitor is connected to an external node.

According to another embodiment, a measurement on-chip of the sideband on the reference clock signal of an SOC by using a PLL 46 to filter out the sideband can be performed. This results in a clean clock signal for the apparatus that measures the sideband level. This enables a measurement on-chip of the reference clock.

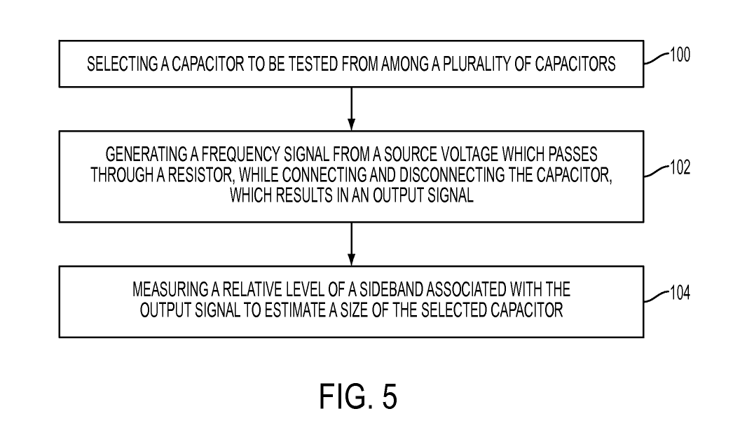

An exemplary method for testing a capacitor in a bank of capacitors is illustrated in FIG. 5. Therein, at step 100, selecting a capacitor to be tested; at step 102, generating a frequency signal from a source voltage which passes through a resistor, while connecting and disconnecting the capacitor between the resistor and a ground, which results in an output signal; and at step 104, measuring a relative level of a sideband associated with the output signal to estimate a size of the selected capacitor. According to an embodiment, for the method shown in FIG. 5, for the highest sideband level, which is associated with the highest measurement accuracy, it can be desirable to minimize the fixed value, i.e., the non-toggling, part. Therefore, according to an embodiment, the remainder of the capacitors can be off. According to an alternative embodiment, the remainder of the capacitors (or some portion thereof) can be on.

The above-described exemplary embodiments are intended to be illustrative in all respects, rather than restrictive, of the present invention. Thus the present invention is capable of many variations in detailed implementation that can be derived from the description contained herein by a person skilled in the art. No element, act, or instruction used in the description of the present application should be construed as critical or essential to the invention unless explicitly described as such. Also, as used herein, the article “a” is intended to include one or more items.

What is claimed is:

1. A method for testing a capacitor, the method comprising:
selecting a capacitor to be tested from among a plurality of capacitors;
generating a frequency signal from a source voltage which passes through a resistor, while connecting and disconnecting the capacitor, which results in an output signal; and
measuring a relative level of a sideband associated with the output signal to estimate a size of the selected capacitor.

2. The method of claim 1, further comprising:
filtering out, by a phase locked loop (PLL), sidebands of the output signal resulting in a second output signal;
converting, by an analog-to-digital converter, the output signal from an analog to a digital signal, resulting in a digital output signal; and
wherein the step of measuring a relative level of a sideband associated with the output signal to estimate a size of the selected capacitor includes:
measuring on-chip, by a cross correlator, the relative level of a sideband associated with the digital output signal.

3. The method of claim 2, wherein the time to test a capacitor is approximately 5-15 μs.

4. The method of claim 1, wherein the resistor in conjunction with the plurality of capacitors to be tested form a low-pass filter.

5. The method of claim 1, wherein the resistor is external to a device including the plurality of capacitors.

6. The method of claim 1, wherein the output signal is a reference clock signal.

7. The method of claim 1, further comprising:
measuring the relative level of the sideband associated with the output signal by a test machine (ATE).

8. The method of claim 7, wherein the measured relative level of the sideband associated with the output signal is proportional to a size of the toggled capacitor relative to a non-toggling capacitor size, wherein the non-toggling capacitor includes all other capacitors in a bank of capacitors.

9. A device configured to test a capacitor, the device comprising:
the device configured to select a capacitor to be tested from among a plurality of capacitors;
a source voltage configured to generate a frequency signal which passes through a resistor, while connecting and disconnecting the capacitor, which results in an output signal; and
the device configured to measure a relative level of a sideband associated with the output signal to estimate a size of the selected capacitor.

10. The device of claim 9, further comprising:
a phase locked loop (PLL) configured to filter out sidebands of the output signal resulting in a second output signal;
an analog-to-digital converter configured to convert the output signal from an analog to a digital signal, resulting in a digital output signal; and
wherein measuring a relative level of a sideband associated with the output signal to estimate a size of the selected capacitor includes:
a cross correlator configured to measure on-chip the relative level of a sideband associated with the digital output signal.

11. The device of claim 10, wherein the time to test a capacitor is approximately 5-15 μs.

12. The device of claim 9, wherein the resistor in conjunction with the plurality of capacitors to be tested form a low-pass filter.

13. The device of claim 9, wherein the resistor is external to a device including the plurality of capacitors.

14. The device of claim 9, wherein the output signal is a reference clock signal.

15. The device of claim 8, further comprising:
a test machine (ATE) configured to measure the relative level of the sideband associated with the output signal.

16. The device of claim 15, wherein the measured relative level of the sideband associated with the output signal is proportional to a size of the toggled capacitor relative to a non-toggling capacitor size.

17. A system for testing a capacitor in a bank of capacitors, the system comprising:
a means for selecting a capacitor in the bank of capacitors to be tested;
a means for generating a frequency signal from a source voltage which passes through a resistor, while connecting and disconnecting the capacitor, which results in an output signal; and
a means for measuring a relative level of a sideband associated with the output signal to estimate a size of the selected capacitor.
